(19) United States
(12) Patent Application Publication
(10) Pub. No.: US 2012/0066107 A1
(43) Pub. Date: Mar. 15, 2012

(54) Method and System for Securing Accounts

(76) Inventor: Sven Grajetzki, London (GB)

(21) Appl. No.: 13/219,031

(22) Filed: Aug. 26, 2011

Related U.S. Application Data
(60) Provisional application No. 61/377,876, filed on Aug. 27, 2010.

(51) Int. Cl. G06Q 40/00

(52) U.S. Cl. 705/35

(57) ABSTRACT

Embodiments of the invention provide a method for securing accounts and financial instruments. A user can use a device in communication with the system to enable or disable access to an accounts. The user can disable access to the account to prevent unauthorized account access, including viewing account information or transaction processing. If access to the account is disabled, the substantially all access to the account can be prevented even if the request to access is accompanied by correct account information or correct payment instructions. For example, if access to the account is disabled, the account can be substantially useless until the user enables access to the account.

### RELATED APPLICATIONS

This application claims priority under 35 U.S.C. §119 to U.S. Provisional Patent Application No. 61/377,876 filed on Aug. 27, 2010 the entire contents of which is incorporated herein by reference.

### BACKGROUND

Many financial transactions can draw funds from accounts for use in purchasing goods and services. The growing incidence of financial illegalities, including fraud and identity theft, can lead to uncertainty about security on the part of at least some consumers and account users. Some accounts, such as credit cards, can be secured using elements such as card verification codes and/or card verification values. However, these security measures can be bypassed by theft of the cards.

### SUMMARY

Some embodiments of the invention provide a method for securing an account. In some embodiments, the method can include securing the account, which can include receiving instructions from a device to disable access to the account. In some embodiments, the instructions can include a user-specific signature. In some embodiments, securing the account can include accessing at least one database and comparing a stored user-unique signature and the user-unique signature received with the instructions. In some embodiments, the instructions can be stored in the database so that the instructions are associated with information related to the account. In some embodiments, securing the account can include transmitting a confirmation to the device to inform a user that the account is disabled. In some embodiments, the method can include receiving at least one request to access the account from a system. In some embodiments, the method can include processing the request to access the account, which can include accessing the database to determine if the database includes stored instructions to disable access to the account. In some embodiments, if the account is disabled, the method can include transmitting a notification to the system that the account cannot be accessed.

### DESCRIPTION OF THE DRAWINGS

FIG. 1 is a perspective view of a system according to one embodiment of the invention.

FIGS. 2A and 2B are front views of a device of the system of FIG. 1.

FIG. 3 is a flowchart of a transaction request using the system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

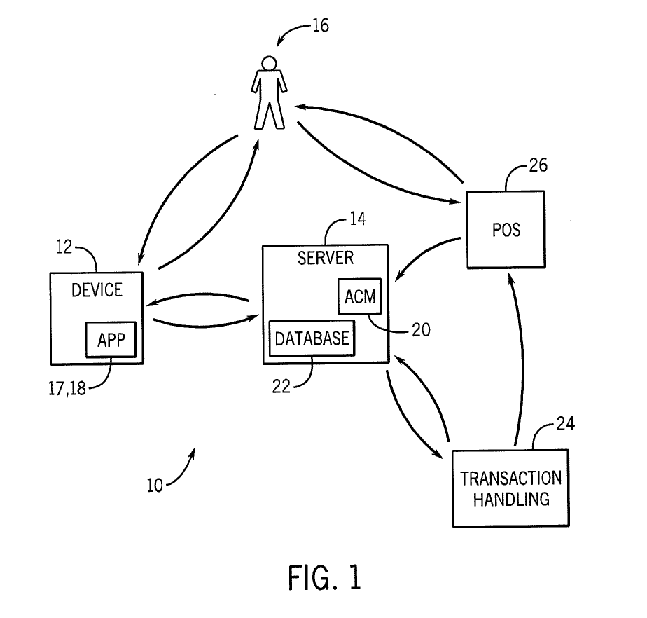

Some embodiments of the invention provide a system 10 for securing accounts and financial instruments. For example, in some embodiments, the system 10 can be used to secure account transactions that occur in a remote capacity (e.g., online accounts) or other capacities, such as financial instruments (e.g., checking account, debit cards, credit cards, gift cards, etc.), as described in further detail below. As shown in FIG. 1, in some embodiments, the system 10 can comprise a device 12 and a server 14. In some embodiments, the device 12 and the server 14 can communicate via wired or wireless communication protocols. In some embodiments, the device 12 can be manipulated by a user 16 to activate or dc-activate a user account 15. For example, in some embodiments, the user 16 can input data into the device 12 to enable and/or disable access to the user account 15.

In some embodiments, the user account 15 can comprise one or more financial accounts. For example, in some embodiments, the user account 15 can include an online bank account or an account associated with a physical card, such as a credit card or a debit card. Furthermore, in some embodiments, the user account 15 can comprise one or more “stored value” accounts, such as, but not limited to e-wallet accounts. Moreover, in some embodiments, the user account 15 can comprise at least one account that is offered by system 10 provider. For example, in some embodiments, the user account 15 can be created by the user 16 using an account system (e.g., a real or virtual bank) that is provided by the same entity as the system 10 provider. In some embodiments, the user account 15 can be created by the user using an account system (e.g., a real or virtual bank) that is provided by a different entity as the system 10 provider, so long as the system 10 and the different account systems can communicate in a secure and compatible manner.

Furthermore, in some embodiments, the user 16 can employ the system 10 to secure disparate user accounts 15. For example, in some embodiments, the user's 16 financial holdings can include multiple user accounts 15 (e.g., bank accounts, credit card accounts, retirement accounts, debit card accounts, health savings accounts, etc.) managed, provided, and/or supported by disparate systems and/or institutions relative to the system 10. In some embodiments, the group of systems and/or institutions providing at least one of the multiple accounts can include the entity providing the system 10. Moreover, in some embodiments, the system 10 can communicate with the disparate systems and/or institutions so that some or all of the multiple user accounts 15 can be enabled or disabled, as described in further detail below. For example, in some embodiments, the user 16 can disable access to all or substantially all of the accounts 15 so that none or most of the accounts 15 can be accessed until the user 16 enables account access via the device 12. Moreover, in some embodiments, the user 16 can selectively enable and/or disable at least a portion of the accounts 15 so that at least a portion of the accounts 15 are substantially inaccessible until the user 16 enables account access via the device 12.

In some embodiments, the system 10 can be configured so that the user 16 can disable the user account 15 during periods that the user 16 does not wish the account 15 to be in an active state and the user 16 can enable the user account 15 as necessary. In some embodiments, the user 16 can activate and deactivate the user account 15 using a master key 17 on the device 12. For example, in some embodiments, by employing the master key 17, the user 16 can enable an “account lock” on the user account 15, while deactivating the master key 17 can disable the account lock on the user account 15. In some embodiments, the master key 17 can be part of an application 18 operating on or by the device 12 that can communicate with the server 14. For example, in some embodiments, the application 18, including the master key 17, can be configured to operate a secure communication avenue between the device 12 and the server 14 so that the user 16 can securely chose whether the account lock should be enabled or disabled.

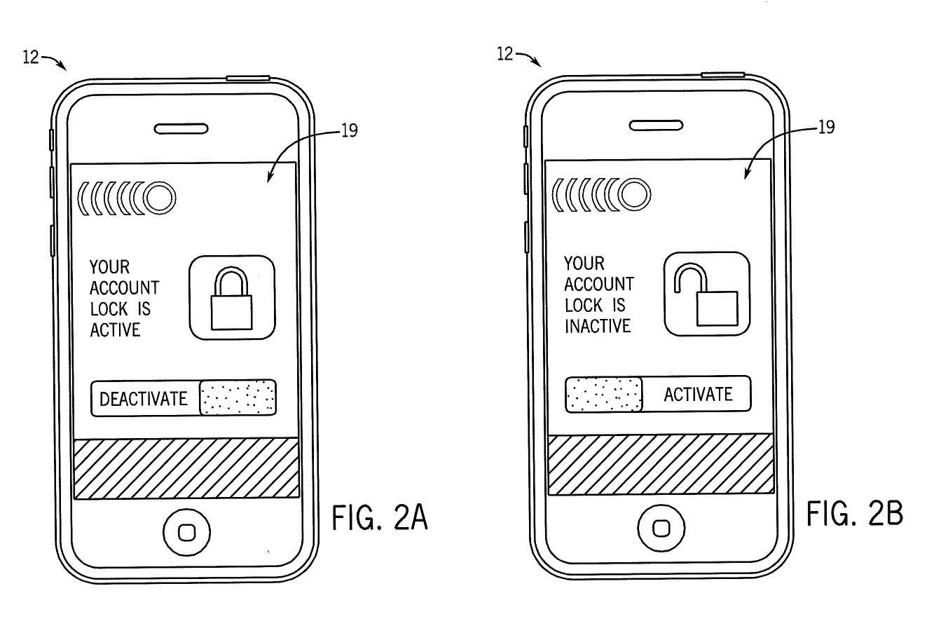

As shown in FIGS. 2A and 2B, in some embodiments, the device 12 can comprise an activated account lock indication and a deactivated account lock indication, respectively. In some embodiments, the device 12 can comprise a mobile phone, smart phone, personal digital assistant, personal computer, an automated teller machine, a banking kiosk, or a similar device that can execute processing instructions, algorithms, or any code of the application 18 and can communicate with the server 14. In some embodiments, as shown in FIGS. 2A and 2B, the device 12 can comprise a user interface 19. For example, in some embodiments, the user interface 19 can comprise a physical keyboard and other physical-interaction features and/or a touch-screen keyboard and other features. Moreover, the user interface 19 can also include controls, such as buttons, scroll wheels, a touch screen (as shown in FIGS. 2A and 2B), etc. to enable the user 16 to activate or deactivate the account lock via the application 18, including employing the master key 17.

In some embodiments, the application 18 can be configured (e.g., securely personalized) by the user 16 for a user account 15 by a secure-setup process. In some embodiments, the setup process can enable the user 16 to create a user-unique signature that can be used for all communications and commands between the server 14 and the application 18 installed on the device 12, so that each user-unique signature corresponds to at least one user account 15. In some embodiments, when the user 16 activates master key 17 via the application 18 on the device 12, the account lock can be enabled on the server 14 for the related user account 15, which can lead to preventing any access to the user account 15 and/or preventing any transactions to be completed using a payment instrument associated with the user account 15 even with correct login credentials or payment instrument details used, as described below.

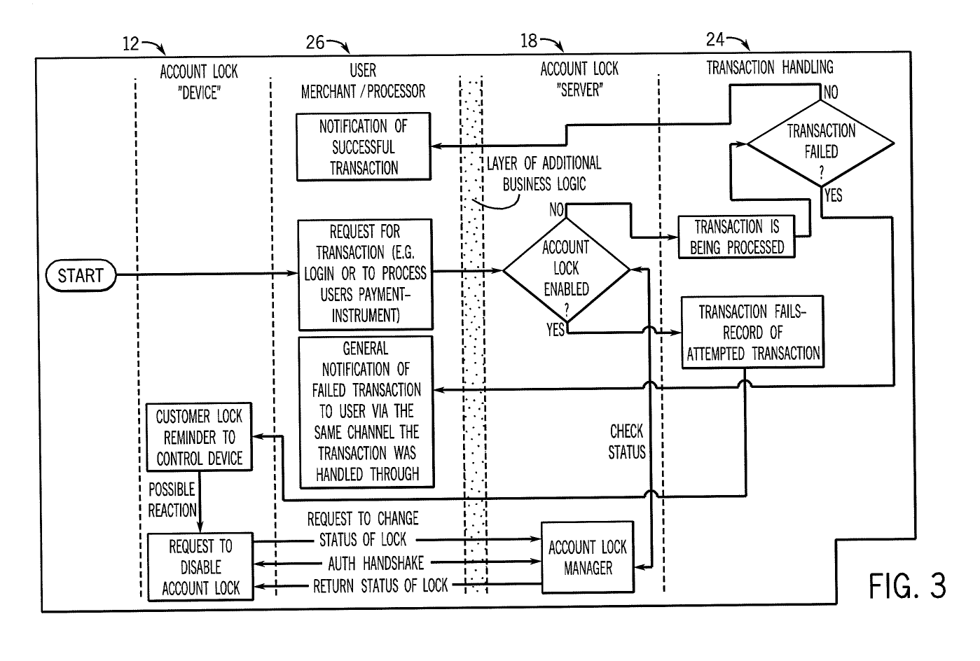

In some embodiments, the server 14 can include an account lock manager 20. In some embodiments, the account lock manager 20 can include at least one database 22 and/or be configured to access to a database 22 of the server 14. In some embodiments, the database 22 can store at least a potion of the information associated with the user accounts 15. Further, the database 22 can also store associated user-unique signatures for each user account 15, account lock status for each user account 15, any other information, or any combination thereof. In some embodiments, the account lock manager 20 can communicate with the master key 17 via the application 18 of the device 12, as shown in FIG. 3.

For example, in some embodiments, when the user 16 enables or disables the master key 17, the account lock manager 20 can receive a request to change a status of the account lock from the device 12 (e.g., from the application 18 on the device 12). In some embodiments, the account lock manager 20 can detect the user-unique signature associated with the device 12 by the request. In some embodiments, the account lock manager 20 can search the database 22 for the user account 15 associated with the user-unique signature and can then send an “authorization handshake” back to the device 12. For example, in some embodiments, the authorization handshake can comprise an indication that the request transmitted from the device 12 to the account lock manager 20 was received and the user-unique signature was determined to be associated with the user account 15.

In some embodiments, if the device 12 transmits an incorrect user-unique signature one or more times to the account lock manager 20, the manager 20 can substantially automatically prevent any access (e.g., including access attempts accompanied by a correct user-unique signature) for a given period of time (e.g., 1 day, 1 week, 1 month, etc.). As a result, in some embodiments, the user accounts 15 can remain substantially secure if the device 12 is lost or stolen and an unauthorized user attempts to enable access to the user accounts 15.

In some embodiments, the system 10 (e.g., the server 14 and/or the account lock manager 20) can comprise an administrative system (not shown). In other embodiments, the system 10 (e.g., the server 14 and/or the account lock manager 20) can be configured to communicate with and/or access the administrative system. In some embodiments, the administrative system can comprise the capability to override the system 10 and/or the account lock manager 20. By way of example only, if the device 12 transmits an incorrect user-unique signature one or more times to the server 14, the administrative system can detect the incorrect user-unique signature (e.g., via communication with the server 14 and/or account lock manager 20), and can substantially override the system 10 and automatically prevent any access (e.g., including access attempts accompanied by a correct user-unique signature) for a given period of time (e.g., 1 day, 1 week, 1 month, etc.). Moreover, in some embodiments, the user 16 can communicate to the administrative system (e.g., via phone, text, e-mail, etc.) that the accounts 15 has been compromised, the device 12 is missing and/or compromised, and/or any other potential issues that could pose a risk to the user accounts 15, and, as a result, regardless of the current state of the user account 15 (e.g., enabled or disabled access), the administrative system can override the system 10 and can either permanently or temporarily prevent any access to the user accounts 15.

Moreover, in some embodiments, the account lock manager 20 can change the account lock status for the user account 15 as requested by the device 12 and can then communicate the changed status of the user account 15 back to the device 12. By way or example only, in some embodiments, upon notice from the device 12, the account lock manager 20 can change the account lock status from enabled to disabled or vice versa in the database 22 so that the user account 15 can be inactivated or activated, respectively. Moreover, in some embodiments, the system 10, via communication between the account lock manager 20 and the device 12, can communicate to the user 16 via the user interface 19 that the change in account lock status has been accomplished, as shown in FIGS. 2A and 2B.

In some embodiments, the server 14 can also be in communication with one or more other systems. For example, in some embodiments, the server 14 can communicate with transaction handling and processing systems 24 and/or an account information, merchant, or point of sale systems 26. In some embodiments, the transaction handling and processing system 24 can receive and process transaction requests from the account information, merchant, or point of sale systems 26 (e.g., the server 14 can substantially function as an intermediary between the account information, merchant, or point of sale systems 26 and the transaction handling and processing systems 24). Moreover, in some embodiments, the transaction requests can include viewing and/or accessing user account information (e.g., through an account website, account management software, an automated teller machine, etc.) or a monetary transaction (e.g., the transfer of money and/or user account credits).

In some embodiments, the account information, merchant, or point of sale systems 26 can submit transaction requests to the server 14 for user account verification and user account status checks prior to being sent to the transaction handling and processing systems 24. In some embodiments, the server 14 can search the database 22 for the user account 15 involved with the transaction request (e.g., the user account 15 to be drawn upon or credited), determine the status of the associated user account 15, and allow or deny processing of the transaction by the transaction handling and processing systems 24 based on the status of the user account 15, as shown in the flowchart of FIG. 3. In some embodiments, if the server 14 allows the transaction (i.e., the account lock is disabled), the user account 15 can be accessed, the transaction can be processed, and the account information, merchant, or point of sale system 26 can be notified of a successful transaction. In some embodiments, if the server 14 denies the transaction (i.e., the account lock is enabled), the account information, merchant, or point of sale system 26 can be notified of a failed transaction.

In some embodiments, the presence of the account lock (i.e., the account lock is active and the account 15 is substantially inaccessible) can be substantially transparent to someone attempting to access the user account 15 or initiate a transaction using an associated payment instrument. For example, in some embodiments, a generic error message or failed transaction message can be displayed and/or presented when the account lock is enabled, which does not indicate what is actually preventing login to the account or execution of the transaction. As a result, the person or system attempting to access the locked user account 15 can be substantially unaware of the locked status of the user account 15.

Furthermore, in some embodiments, in the event of a failed transaction due to an enabled account lock, the user 16 can be notified via the application 18. For example, in some embodiments, the server 14 can communicate with the device 12 to transmit notification that an attempt was made to access the user account 15. In some embodiments, application 18 can offer the user 16 the option of deactivating the account lock and re-attempting the transaction. In some embodiments, the application can offer the user 16 other options, such as taking appropriate action if the original transaction attempt was made without the user's knowledge (e.g., contacting the financial institution hosting the user account 15). Moreover, in some embodiments, the server 14 can provide a time frame (e.g., 10 minutes, 1 hour, 1 day, etc.) in which the user 16 can deactivate the account lock to allow the original transaction to be processed (i.e., without having to retry the transaction). Accordingly, if the time frame has surpassed and the user 16 has still not deactivated the account lock, the server 14 can deny processing of the transaction by the transaction handling and processing system 24 and the account information, merchant, or point of sale system 26 can be notified of the failed transaction.

In some embodiments, the system 10 can comprise alternate configurations. In some embodiments, the user 16 can configure the system 10 so that at least a portion of the user accounts 15 can be substantially automatically protected. In some embodiments, the user 16 can configure the account lock manager 20 via the application 18 so that after enabling access to at least a portion of the user accounts 15, the account lock manager 20 or other portions of the system 10 (e.g., the application 18 on the device 12) can substantially automatically disable access to the user accounts 15 (i.e. change the access state of the account 15 in the database 22 to disabled). For example, in some embodiments, the user 16 can select a pre-determined timeframe (e.g., 10 minutes, 1 hour, 6 hours, 1 day, 1 week, etc.) that the account 15 can remain accessible, so that after the user 16 enables access, the account lock manager 20 can substantially automatically store in the database 22 after the pre-determined timeframe so that access to the account 15 is substantially automatically disabled. As a result, in some embodiments, the user 16 can be assured that should they neglect to disable access to the account 15, the account 15 can still be secured substantially automatically after the pre-determined timeframe.

In some embodiments, the system 10 can comprise other features. In some embodiments, the value of the financial transaction can at least partially determine whether the account 15 can be accessed. For example, in some embodiments, the user 16 can instruct the account lock manager 20 via the application 18 to store instructions in the database 22 that can at least partially limit access to the accounts 15 based on the size of the transaction. In some embodiments, the user 16 can substantially enable access to the account 15 for some or all transactions under a certain financial value (e.g., $10, $50, $100. $500, etc.). As a result, in some embodiments, the user 16 need not worry about relatively low risk financial transactions (e.g., low cash value transactions) so that if the user 16 desires to make a small purchase, there would be a reduced need to enable access to the account 15. Moreover, the user 16 can still be assured that larger financial transaction still require enabling access to the accounts 15 so that the user 16 can be assured of relatively secure accounts 15.

As a result, some embodiments can provide enhanced security for user accounts 15. For example, in some embodiments, the user 16 can be reasonably certain that even if the user account 15 or payment instrument details have been compromised through phishing or skimming attacks, the user account 15 is only vulnerable during the minimal timeframe in which the user 16 enables the user account 15 (i.e., by deactivating the master key 17). Accordingly, at substantially all other times, the user account 15 can be rendered essentially inaccessible by the system 10.

The software instructions and algorithms described above, as well as additional software instructions or algorithms to perform specific elements of the above-described processes or methods can be stored on computer readable media and can be carried out or executed by a processor of the server 14 or the device 12. For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data may be processed by other computers on the network, e.g. a cloud of computing resources.

The embodiments of the present invention can also be defined as a machine that transforms data from one state to another state. The data may represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

The invention can also be embodied as computer readable code on a computer readable medium. The computer readable medium may be any data storage device that can store data, which can thereafter be read by a computer system. Examples of the computer readable medium include hard drives, network attached storage (NAS), read-only memory, random-access memory, FLASH based memory, CD-ROMs, CD-Rs, CD-RWs, DVDs, magnetic tapes, other optical and non-optical data storage devices, or any other physical or material medium which can be used to tangibly store the desired information or data or instructions and which can be accessed by a computer or processor. The computer readable medium can also be distributed over a network coupled computer systems so that the computer readable code may be stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way. It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A method of securing a user account, the method comprising:
creating a user-unique signature for a device, including receiving data input by a user on the device;
receiving the user-unique signature from the device;
storing the user-unique signature in at least one database, the at least one database including stored information relating to the user account, and wherein the user-unique signature is associated with the stored information related to the user account in the at least one database;
receiving instructions from the device to disable access to the user account, the instructions including the user-specific signature;
accessing the at least one database to compare the stored user-unique signature and the user-unique signature received with the instructions;
storing the instructions to disable access in the at least one database so that the instructions are associated with the stored information related to the user account;
transmitting a confirmation to the device to inform the user that the user account is disabled; and
preventing substantially all access to the user account.

2. The method of claim 1 and further comprising receiving a second set of instructions from the device to enable access to the user account, wherein the instructions include the user-specific signature.

3. The method of claim 2 and further comprising accessing the at least one database to compare the stored user-unique signature and the user-unique signature received with the second set of instructions;
storing the second set of instructions to enable access to the user account in the at least one database so that the instructions are associated with the stored information related to the user account; and
transmitting a confirmation to the device to inform the user that the user account is enabled.

4. The method of claim 1 and further comprising receiving instructions from the device to substantially automatically disable access to the user account after a pre-determined timeframe, wherein the instructions include the user-specific signature; and storing the instructions to substantially automatically disable access to the user account after a pre-determined timeframe in the at least one database so that the instructions are associated with the stored information related to the user account.

5. The method of claim 1, wherein the user account comprises at least one of a credit card account, a bank account, and a stored value account.

6. The method of claim 1, wherein the device comprises at least one of a mobile phone, a smart phone, a personal computer, an automated-teller machine, and a personal digital assistant.

7. The method of claim 1, wherein preventing all access comprises preventing attempts to access the user account that include correct user-account login credentials.

8. The method of claim 1, wherein the device is capable of wirelessly transmitting the instructions to disable the user account.

9. A method for securing and accessing an account, the method comprising:
securing the account including
receiving instructions from a device to disable access to the account, the instructions including a user-specific signature,
accessing at least one database and comparing a stored user-unique signature and the user-unique signature received with the instructions,
storing the instructions to disable access in the at least one database so that the instructions are associated with information related to the account, and
transmitting a confirmation to the device to inform a user that the account is disabled;
receiving at least one request to access the account from a system;
processing the at least one request to access the account including accessing the at least one database to determine if the at least one database includes stored instructions to disable access to the account; and
transmitting notification to the system that the account cannot be accessed.

10. The method of claim 9, wherein the notification that the account is disabled includes a failed account access message that does not indicate that the account is disabled.

11. The method of claim 9 and further comprising transmitting a notification to the device that the system attempted to access the account.

12. The method of claim 11 and further comprising receiving a second set of instructions from the device to enable access to the account, wherein the instructions include the user-specific signature.

13. The method of claim 12 and further comprising accessing the at least one database to compare the stored user-unique signature and the user-unique signature received with the second set of instructions;
storing the second set of instructions to enable access to the user account in the at least one database so that the instructions are associated with the stored information related to the account;
transmitting a confirmation to the device to inform the user that the user account is enabled; and
transmitting notification to the system that the account can now be accessed.

14. The method of claim 9, wherein the system comprises at least one of an account information system, a merchant system, and a point of sale system.

15. The method of claim 9, wherein the user account comprises at least one of a credit card account, a bank account, and a stored value account.

16. The method of claim 9 and further comprising receiving a third set of instructions from the device to enable access to the user account for at least a portion of requests to access the account from the system when a financial value of the requests is less than or equal to a pre-determine financial value, wherein the third set of instructions includes the user-specific signature, and storing the third set of instructions in the at least one database so that the third set of instructions are associated with the stored information related to the user account.

17. The method of claim 9, wherein the device comprises at least one of a mobile phone, a smart phone, a personal computer, an automated-teller machine, and personal digital assistant.

18. The method of claim 9, wherein the device is capable of wirelessly transmitting the instructions to disable the account.

19. A system for securing an account, the system comprising:
at least one account lock server including at least one database, the at least one account lock server configured to
receive instructions from an application operating on a device, the instructions including notice to the account locker server to disable access to the account and a user-specific signature;
process the instructions from the application including
accessing the at least one database to compare a stored user-unique signature and the user-unique signature received with the instructions, and
storing the instructions to disable access to the account in the at least one database so that the instructions are associated with information related to the account if the user-specific signature received with the instructions and the user-specific signature stored in the database are the same;
transmit a confirmation to the device to inform a user that the account is disabled; and
prevent substantially all access to the account.

20. The system of claim 19, wherein the device comprises at least one of a mobile phone, a smart phone, a personal computer, an automated-teller machine, and a personal digital assistant.
